(19) United States
(12) Patent Application Publication
(10) Pub. No.: US 2006/0134298 A1
(43) Pub. Date: Jun. 22, 2006

(54) Dairy product and process

(76) Inventors: Keith Johnston, Palmerston North (NZ); Tim Carroll, Palmerston North (NZ); Craig Honore, Palmerston North (NZ); Vaughan Crow, Palmerston North (NZ); Nicola White, Palmerston North (NZ); Ping Chen, Guangzhou (CN)

Correspondence Address: KNOBBE MARTENS OLSON & BEAR LLP, 2040 MAIN STREET, FOURTEENTH FLOOR, IRVINE, CA, 92614, US

(21) Appl. No.: 10/535,784

(22) PCT Filed: Nov. 20, 2003
(86) PCT No.: PCT/NZ03/00257

§ 371 Date: Nov. 25, 2005

(30) Foreign Application Priority Data
Nov. 20, 2002 (NZ) 522750

(51) Int. Cl. A23C 19/00

(52) U.S. Cl. 426/582

(57) ABSTRACT

Described are methods for retarding or inhibiting the breakdown of intact casein in cheese using high pressure treatments. Also described are methods of making processed cheese using pressure treated cheese.

### FIELD OF INVENTION

The present invention relates to a method of retarding or inhibiting casein breakdown in cheese and to the manufacture of cheese products using pressure treated cheese.

### BACKGROUND

Formation of a milk coagulum is an early and important stage of the cheesemaking process, serving to capture the milk components (fat, protein, lactose, salts, micro organisms and water) in a gel network. Proteolytic cleavage of the protruding hydrophilic region of kappa-casein by the milk coagulating enzyme causes destabilisation of repulsive interactions that retain casein micelles in a colloidal suspension. Aggregation of the casein occurs, and a three dimensional network is formed that, with time, firms to produce a curd able to be cut and made into cheese.

In addition to its role in the clotting of milk, coagulant that remains entrapped in the curd after coagulum formation plays a role in the ripening and aging of the cheese. Residual coagulant breaks down proteins into smaller peptides. This action produces the precursors to subsequent flavour compounds, and softens and smooths the rubbery texture. The textural changes seen are associated with disruption of the protein (casein) matrix of a cheese, and are typically attributed to action of the coagulant enzyme on alpha s1-casein (and to a lesser extent beta-casein depending on the cheese and coagulant type). The rate of casein breakdown in a cheese is dictated by the quantity of coagulant, temperatures used during its manufacture, final cheese composition and pH.

Post-production, the rate of casein breakdown can be controlled to a limited degree by selection of appropriate storage temperatures (where slower breakdown is observed at lower temperature, and faster breakdown is observed at elevated temperatures).

The ability to slow the rate of casein breakdown in cheese is commercially advantageous in several ways. For example, the manufacture of processed cheese requires a young cheese with a high level of intact casein, and during storage this level of intact casein in young cheeses declines.

Mozzarella is a cheese for which limited or controlled casein breakdown is important in maintaining the functionality that gives acceptable performance when used on a pizza, that is melt and stretch. Some time after manufacture when the appropriate degree of casein breakdown has occurred, Mozzarella cheese is functionally optimum for pizza applications. Acceptable functionality is maintained for a period of time and deteriorates as casein breakdown proceeds.

It is an object of the present invention to provide an improved or alternative method of retarding or inhibiting the breakdown of casein in cheese.

### SUMMARY OF INVENTION

In one aspect the invention broadly comprises a method of retarding or inhibiting the breakdown of intact casein in a cheese comprising subjecting the cheese to a pressure treatment of greater than 400 MPa.

Preferred pressures useful according to the present invention may be selected from 410 MPa, 420 MPa, 430 MPa, 440 MPa 450 MPa, 460 MPa, 470 MPa, 480 MPa, 490 MPa, 500 MPa, 510 MPa, 520 MPa, 530 MPa, 540 MPa, 550 MPa, 560 MPa, 570 MPa, 580 MPa, 590 MPa, 600 MPa, 610 MPa, 620 MPa, 630 MPa, 640 MPa, 650 MPa, 660 MPa, 670 MPa, 680 MPa, 690 MPa, 700 MPa, 710 MPa, 720 MPa, 730 MPa, 740 MPa, 750 MPa, 760 MPa, 770 MPa, 780 MPa, 790 MPa, 800 MPa, 810 MPA, 820 MPa, 830 MPa, 840 MPa, 850 MPa, 860 MPa, 870 MPa, 880 MPa and 890 MPa.

Preferably the cheese is held at the specified pressure for a duration of about 5 minutes, although shorter holding times are envisaged and within the scope of the invention.

Preferably the cheese is pressure treated within 30 days of being drained, more preferably within 5 days of being drained, and most preferably within 24 hours of being drained.

In a preferred embodiment, the pressure treated cheese is a pasta filata cheese, preferably a pizza cheese, and most preferably a mozzarella cheese.

In a second aspect, the invention broadly comprises a method of making a cheese product comprising heating one or more cheeses with one or more emulsifying agents, wherein at least one cheese has been treated by a method according the first aspect of the invention.

Preferred cheese products made according to this aspect of the invention are processed cheeses, processed cheese foods and processed cheese spreads.

The invention also comprises products made from the methods described above and throughout this specification.

### BRIEF DESCRIPTION OF THE DRAWINGS

FIGS. 1a, 1b and 1c are graphs showing the breakdown of casein in cheeses over time. Cheeses were subjected to varying pressure treatments and were tested for levels of casein over periods of time ranging from 0 days (i.e. immediately) to 120 days. The pressure treatments used ranged from 0 (control) to 800 MPa.

FIGS. 2a, 2b and 2c are graphs showing the breakdown of casein in Mozzarella cheese over time. Mozzarella cheeses were subjected to varying pressure treatments and were tested for levels of casein over periods of time ranging from 0 days (i.e. immediately) to 42 days. The pressure treatments used ranged from 0 (control) to 800 MPa.

### DETAILED DESCRIPTION

As mentioned herein, references to “pressure treatment” or “UHP treatment” mean ultra high-pressure treatments. Such treatments are generally accepted as pressure treatments using pressures of at least 100 MPa. This is also known in the art as “high pressure”, “high hydrostatic pressure” (HHP) or “high pressure processing” (HPP).

A pressure treatment is understood to comprise the following steps:
placing a food into the chamber and sealing the chamber,
raising the pressure in the chamber, and thereby the food to a predetermined set pressure,
holding the food at this pressure for a specified time (termed the treatment time, dwell time or hold time), and
releasing the pressure from the chamber and removing the food.

Throughout this specification, references to subjecting a cheese to a pressure treatment for a specified length of time at a specified pressure refer to the length of time that the cheese is subjected to that specified pressure.

The characteristics of the high-pressure equipment used might affect the conditions required to successfully perform the invention. In particular, the time taken to achieve the treatment pressure and to release the treatment pressure from the food, and the accuracy with which the treatment pressure is delivered and controlled may influence the outcomes, particularly in situations where it is not necessary for the food to be held at the treatment pressure for an appreciable time.

Processed Cheese is produced by blending shredded natural cheeses of different types and degrees of maturity with emulsifying agents, and by heating the blend under a partial vacuum with constant agitation until a homogenous mass is obtained. In addition to natural cheeses, other dairy and non-dairy ingredients may be included in the blend (Fox, Chapter 15, p 467).

The type and amount of cheese and other ingredients are determined by a number of factors, including cost, availability, type of finished product and country specific labelling regulations. Typically different ingredients are blended to achieve the balance of minimised formulation cost, and final product flavour and functionality.

When manufacturing Processed Cheese, in particular blocks and slices, a particularly high proportion of relative (or intact) casein is required (Joha™ Guide to Processed Cheese Manufacture, p 77) to deliver the exacting functional requirements of these products. Functional properties for slices include elasticity, rigidity and resistance to melt.

Processed cheese is generally made using semi-hard to hard cheese, made by either a cheddar or granular process with FDM (fat in dry matter) greater than 48%, and a moisture content of less than 39%.

Historically, loss of intact casein has only been controlled to a limited extent by control of storage temperature.

The ability to maintain the attributes of a young cheese for an extended period of time effectively separates the cheese supply from both the cheese manufacture and the processed cheese manufacture. A cheese in which the attributes of a young cheese are maintained for an extended period of time may be of greater value in having a higher level of intact casein, as well as being more functionally stable and consistent than a comparable cheese for which the attributes of a young cheese are not maintained. Such a cheese also offers greater flexibility to the processed cheese manufacturer.

Mozzarella, (and varieties such as part skim Mozzarella and pizza cheese), require an additional ‘pasta filata’ or stretching step during manufacture, where curd is heated to 55° C. or greater and mechanically stretched before moulding and packaging. This stretching process causes the cheese to develop a fibrous and malleable texture.

The functional properties of Mozzarella cheese such as meltability and stretchability determine the suitability of the cheese for use in pizza applications. It is known that pizza cheese changes in functionality with age, and that freshly-made Mozzarella cheese is unsuitable for pizza because of poor melatibility and limited stretch. With further ageing, the functionality changes to the point where the cheese is suitable for pizza, whereupon with further ageing the cheese again becomes unsuitable for pizza because of excessive softness on melting. The time over which Mozzarella cheese can be used in pizza applications may be relatively short.

Mozarella is generally understood as being semi-soft cheese made by the pasta filata process with an FDM greater than 30% and a moisture content of less than 60%.

Limited or controlled casein breakdown is important in maintaining the functionality that gives Mozzarella cheese excellent performance characteristics when used on a pizza, that is melt and stretch.

Some time after manufacture, when an appropriate degree of casein breakdown has occurred, Mozzarella functionality is optimal, and is maintained for a period, but then deteriorates with extensive casein breakdown.

The invention consists in the foregoing and also envisages constructions of which the following gives examples.

### EXAMPLES

The following examples show how the rate of casein breakdown can be slowed in cheeses by subjecting them to pressure treatments. Example 7 demonstrates that pressure treated cheeses may be used for applications such as the manufacture of processed cheese.

### Example 1

The Use of a Pressure Treatment to Restrict Protein Breakdown in a Cheese Made with Calf Rennet.

A cheese vat was filled with 350 L of pasteurised milk that had been standardised to a protein to fat ratio of 0.81. The temperature of the cheese milk was adjusted to 32 degrees Celsius. Mesophilic starter and CaCl₂ were added at the rate of 2.4% and 0.02% respectively, and were mixed with the cheese milk.

A quantity of calf rennet was added to the cheesemilk, and after about 20 minutes setting time, the gel was cut using a 6 mm curd knife. While being stirred, the curds and whey were then heated to 38.5 degrees Celsius over 40 minutes, and allowed to cook.

The whey was drained from the curds after a further 2¾ hours. The curd was stirred six times in the first 18 minutes, then three times in the following 15 minutes and then once every 10 minutes. Once the pH reached approximately 5.2, salt was applied to the curd at the rate of 22 g/kg. The curd was mellowed for a further 20 minutes, then pressed into 20 kg blocks (0.4 MPa) overnight.

A summary table of cheese composition of product exiting the press is presented in the following table.

| Component | % |
|---|---|
| moisture | 32.9 |
| fat | 36.0 |
| salt | 1.8 |
| S/M | 5.5 |
| FDM | 54 |
| MNFS | 51 |

On removal from the cheese press after 16 hours pressing time, 600 g portions of the cheese were divided from the cheese block and treated at varying pressures for 5 minutes.

All blocks were then stored at 10 degrees Celsius for 4 months and sub-sampled at regular intervals. The level of intact casein was determined using alkaline urea PAGE (Creamer 1991).

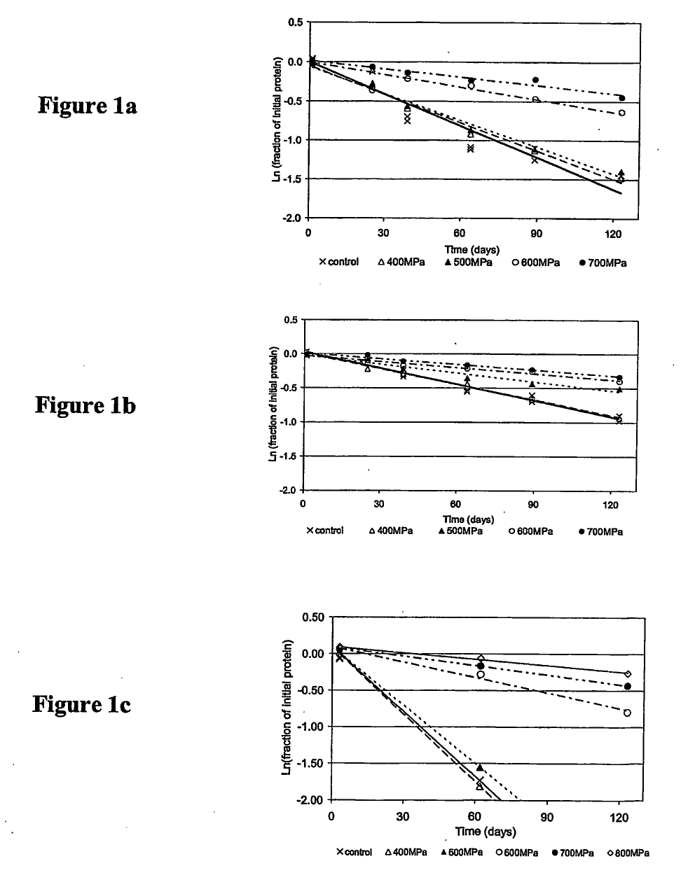

A summary of results from alkaline urea PAGE analyses of ultra-high pressure cheese are shown in FIG. 1a. Rate of alpha s1-casein decay was plotted and correlated using log-linear plots and showed that the pressure treatments had an effect on the rate of alpha s1-casein breakdown. When cheese was treated at >400 MPa for 5 min, decreased rates of alpha s1-casein breakdown were observed. The reduced rate of alpha s1-casein breakdown was estimated and expressed as a percentage of the untreated cheese (control) and is summarised in the following table.

| | |
|---|---|
| Pressure | Observed rate of casein breakdown |
| treatment | (compared to control, %) |

| (MPa) | Alpha s1-casein | Alpha s1 + beta casein |
|---|---|---|
| control | 100 | 100 |
| 400 | 89 | 102 |
| 500 | 85 | 106 |
| 600 | 39 | 70 |
| 700 | 26 | 60 |

### Example 2

The Use of Pressure Treatment to Restrict Protein Breakdown in a Cheese Made with a Microbial Rennet.

Cheese was made in a similar manner to the method described in Example 1, but Fromase_{XL}™ (derived from Rhizomucor miehei) was used as the milk coagulant.

A summary table of composition of cheese exiting cheese press is presented in the following table.

| Component | % |
|---|---|
| moisture | 32.0 |
| fat | 36.0 |
| salt | 1.8 |
| S/M | 5.6 |
| FDM | 54 |
| MNFS | 51 |

On removal from the cheese press after 16 hours of pressing time, 600 g portions of the cheese were divided from the cheese block and treated at varying pressures for 5 minutes.

All blocks were then stored at 10 degrees Celsius for 4 months and were sub-sampled at regular intervals. The level of intact casein was determined using alkaline urea PAGE (Creamer 1991). When cheese was treated at pressures >400 MPa, slower rates of alpha _{S1}-casein breakdown were observed when compared to the untreated cheese (control). This trend is demonstrated in FIG. 1b.

The rate of alpha _{S1}-casein decay was plotted and correlated using log-linear plots and showed that the pressure treatments had a significant effect alpha _{S1}-casein breakdown. When cheese was treated at >400 MPa for 5 min, decreased rates of alpha _{S1}-casein breakdown were observed. The reduced rate of alpha _{S1}-casein breakdown was estimated and expressed as a percentage of the untreated cheese (control). These results are presented in the following table.

| | |
|---|---|
| Pressure | Observed rate of alpha _{S1}-casein |
| treatment | breakdown (compared to control, %) |

| (MPa) | Alpha s1 casein | Alpha s1 + beta casein |
|---|---|---|
| control | 100 | 100 |
| 400 | 96 | 105 |
| 500 | 54 | 75 |
| 600 | 38 | 64 |
| 700 | 34 | 65 |

### Example 3

The Use of Pressure Treatment in Restricting Protein Breakdown in a Cheese Made with Calf Rennet.

A cheese vat was filled with 350 L of pasteurised milk that had been standardised to a protein to fat ratio of 0.73. The temperature of the cheese milk was adjusted to 32 degrees Celsius. Mesophilic starter at the rate of 1.8%, was added and mixed with the cheese milk.

A quantity of calf rennet was added to the cheesemilk, and after about 20 minutes setting time, the gel was cut using a 9 mm curd knife. While being stirred, the curds and whey were heated to 37.5 degrees Celsius over 40 minutes, and allowed to cook.

The whey was drained from the curds after a further 2½ hours. The curd was stirred twice in the first 10 minutes, and then allowed to cheddar. Once the pH reached approximately 5.3 curd was milled into small pieces and salt applied to the curd at the rate of 25 g/kg. The curd was mellowed for a further 20 minutes, then pressed into 20 kg blocks (0.4 MPa) overnight.

A summary table of cheese exiting press is presented in the following table.

| Component | % |
|---|---|
| moisture | 35.5 |
| fat | 38.0 |
| salt | 1.8 |
| S/M | 5.1 |
| FDM | 59 |
| MNFS | 57 |

On removal from the cheese press, 20 kg blocks were bagged and stored at 10 degrees Celsius. Three days after manufacture portions of the cheese (600 g) were divided from the cheese block and treated at varying pressures for 5 minutes.

All blocks were then stored at 13 degrees Celsius for an extended period and sub-sampled at regular intervals. The level of casein breakdown was determined using alkaline urea PAGE (Creamer 1991).

A summary of results from alkaline urea PAGE analyses of ultra-high pressure cheese are shown in FIG. 1c. Rate of alpha _{S1}-casein decay was plotted and correlated using log-linear plots and showed that ultra-high pressure treatment had a significant effect alpha _{S1}-casein breakdown. When cheese was treated at >400 MPa for 5 min, we observed decreased rates of alpha _{S1}-casein breakdown. The reduced rate of alpha _{S1}-casein breakdown was estimated and expressed as a percentage of the untreated cheese (control). These results are summarised in the following table.

| | |
|---|---|
| Pressure | Observed rate of alpha _{S1}-casein |
| treatment | breakdown (compared to control, %) |

| (MPa) | Alpha s1-casein | Alpha s1 + beta casein |
|---|---|---|
| control | 100 | 100 |
| 400 | 104 | 90 |
| 500 | 90 | 91 |
| 600 | 24 | 54 |
| 700 | 15 | 41 |
| 800 | 10 | 36 |

### Example 4

The Use of Pressure Treatments to Restrict Protein Breakdown and Preserve Functionality in Mozzarella Cheese Made with Calf Rennet.

A cheese vat was filled with 350 L of pasteurised milk that had been standardised to a protein to fat ratio of 1.3. The temperature of the cheese milk was adjusted to 32 degrees Celsius. Thermophilic starter at the rate of 1.5% was added and thoroughly mixed with the cheese milk.

A quantity of calf rennet was added to the cheesemilk, and after about 30 minutes setting time, the gel was cut using a 12 mm curd knife. While being stirred, the curds and whey were then heated to 40 degrees Celsius over 30 minutes, and allowed to cook. The whey was drained from the curds after a further 1 hours of stirring at 40 degrees Celsius. The curd was allowed to cheddar. Once the pH reached approximately 5.4, the curd was milled into small pieces and salt applied at the rate of 23 g/kg.

Following 20 min mellowing time, the curd was stretched at 58-60 degrees Celsius (curd temperature) for approximately 6 minutes. Molten curd was placed in plastic bag lined moulds and cooled in chilled water for not less than 3 hours. Following initial cooling, blocks were de-moulded, bags vacuum-sealed and stored at 5 degrees Celsius.

The composition of the Mozzarella cheese composition is presented in the following table.

| Component | % |
|---|---|
| moisture | 46 |
| fat | 22.5 |
| salt | 1.21 |
| S/M | 2.6 |
| FDM | 42 |
| MNFS | 59 |

Mozzarella was held at 5 degrees Celsius for 3 weeks to develop functional characteristics suitable for use in pizza application. Portions of 600 g were divided from the block and treated at varying pressures for 5 minutes.

Blocks were stored at 5 degrees Celsius, sub-sampled and assessed at 6 weeks.

When tested in pizzas, Mozzarella cheeses treated in accordance with the present invention were still of acceptable functionality at 6 weeks, as compared to the untreated cheeses which were only of acceptable functionality between 3 and 6 weeks. Overall, UHP treatments of greater than 400 MPa resulted in extended periods of acceptable functionality of Mozzarella cheese in pizza applications.

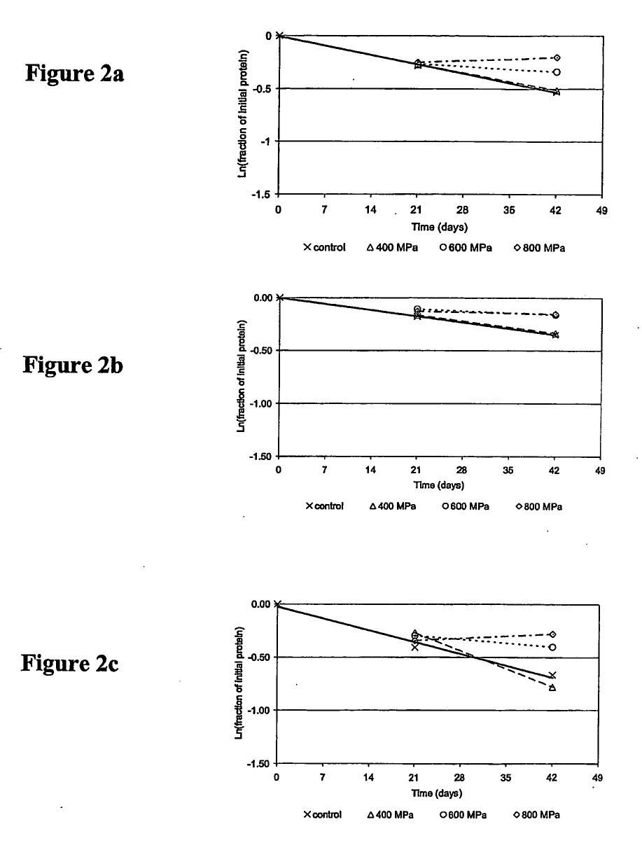

The rate of casein breakdown was plotted and correlated using log-linear plots and shows that ultra-high pressure treatment has an effect of intact casein levels (see FIG. 2a). When cheese is treated at >400 MPa for 5 min, decreased rates of casein breakdown were observed. The reduced rate of casein breakdown was estimated and expressed as a percentage of the untreated cheese (control), and this data is presented in the table below.

| Pressure treatment | Observed rate of casein breakdown |
|---|---|
| (MPa) | (compared to control, %) |
| control | 100 |
| 400 | 93 |
| 600 | 28 |
| 800 | <10 |

### Example 5

The Use of Ultra-High Pressure to Restrict Protein Breakdown and Preserve Functionality in Mozzarella Cheese Made with a Microbial Rennet.

Mozzarella was made in a similar manner to the method described in Example 4, but Fromase_{XL}™ was used as the milk coagulant.

A summary table of Mozzarella composition is presented in the following table.

| Component | % |
|---|---|
| moisture | 46 |
| fat | 22.5 |
| salt | 1.14 |
| S/M | 2.5 |
| FDM | 42 |
| MNFS | 59 |

Mozzarella was held at 5 degrees Celsius for 3 weeks to develop functional characteristics suitable for use in pizza application. Portions of 600 g were divided from the block and treated at varying pressures for 5 minutes.

Blocks were stored at 5 degrees Celsius, sub-sampled and assessed at 6 weeks.

When tested in pizzas, Mozzarella cheeses treated in accordance with the present invention were still of acceptable functionality at 6 weeks, as compared to the untreated cheeses which were only of acceptable functionality between 3 and 6 weeks. Overall, UHP treatments of greater than 400 MPa resulted in extended periods of acceptable functionality of Mozzarella cheese in pizza applications.

Rate of casein breakdown is plotted and correlated using log-linear plots and shows that ultra-high pressure treatment has an effect of intact casein levels (see FIG. 2b). When cheese is treated at >400 MPa for 5 min, decreased rates of casein breakdown were observed, indicating slower proteolysis. The reduced rate of casein breakdown was estimated and expressed as a percentage of the untreated cheese (control), this data is presented in the following table.

| Pressure treatment | Observed rate of casein breakdown |
|---|---|
| (MPa) | (compared to control, %) |
| control | 100 |
| 400 | 100 |
| 600 | 31 |
| 800 | 14 |

### Example 6

The Use of Ultra-High Pressure to Restrict Protein Breakdown and Preserve Functionality in Mozzarella Cheese Made with a Microbial Rennet.

Mozzarella was made in a similar manner to the method described in Example 4, but Surecurd (derived from Endothia parasitica) was used as the milk coagulant.

A summary table of Mozzarella composition is presented in the table below.

| Component | % |
|---|---|
| moisture | 46 |
| fat | 22.5 |
| salt | 1.18 |
| S/M | 2.6 |
| FDM | 42 |
| MNFS | 60 |

Mozzarella was held at 5 degrees Celsius for 3 weeks to develop functional characteristics suitable for use in pizza application. Portions of 600 g were divided from the block and treated at varying pressures for 5 minutes.

Blocks were stored at 5 degrees Celsius, sub-sampled and assessed at 6 weeks.

When tested in pizzas, Mozzarella cheeses treated in accordance with the present invention were still of acceptable functionality at 6 weeks, as compared to the untreated cheeses which were only of acceptable functionality between 3 and 6 weeks. Overall, UHP treatments of greater than 400 MPa resulted in extended periods of acceptable functionality of Mozzarella cheese in pizza applications.

Rate of casein breakdown is plotted and correlated using log-linear plots and shows that ultra-high pressure treatment has a significant effect of intact casein levels (see FIG. 2c). When cheese was treated at >400 MPa for 5 min, decreased rates of casein breakdown were observed. The reduced rate of casein breakdown was estimated and expressed as a percentage of the untreated cheese (control), this data is presented in the following table.

| Pressure treatment | Observed rate of casein breakdown |
|---|---|
| (MPa) | (compared to control, %) |
| control | 100 |
| 400 | >130 |
| 600 | 31 |
| 800 | 19 |

### Example 7

Manufacture of a Processed Cheese from Ultra-High Pressure Treated Cheese

Cheese was made as in Example 1, but Fromase_{XL} (Rhizomucor miehei) was used as the milk coagulant. A summary table of cheese composition of product exiting press is presented in the following table.

| Component | % |
|---|---|
| moisture | 32.9 |
| fat | 36.5 |
| salt | 1.4 |
| S/M | 4.3 |
| FDM | 54 |
| MNFS | 52 |

The cheeses were pressed for 16 hours, then 600 g portions of the cheese were divided from the cheese block and treated at 600 MPa for 5 minutes.

Cheese was then stored at 10 degrees Celsius for an extended period and sub-sampled at regular intervals. The level of intact casein was determined using alkaline urea PAGE (Creamer 1991).

Casein breakdown in cheese treated with high pressure (600 MPa) was maintained at higher levels over the 6-month storage period when compared to untreated cheese (control). The pressure treated cheese had an intact casein level of 73% after 6 months, while the untreated cheese had intact casein levels of 43% after 2 months and 28% after 6 months. Processed cheese made from 2 and 6 month old untreated cheese was thinner in body than processed cheese made from 6 month old pressure treated cheese.

The ingredients in table 1 were reduced to a uniform particle size by passing through a 5 mm cheese grinder and then placed in a 25 kg capacity Blentech (model CC45) cooker. The ingredients in table 2 were also added to the cheese in the Blentech cooker.

TABLE 1

| Ingredients | Kg |
|---|---|
| 600 MPa ultra-high pressure treated cheese | 2.80 |
| (6 months age) | |
| Medium cheese | 2.14 |
| Mature cheese | 0.86 |
| Butter | 0.62 |

TABLE 2

| Ingredients | Kg |
|---|---|
| Melting salts | 0.238 |
| Salt | 0.065 |
| Rework cheese | 0.180 |
| Sorbic acid | 0.008 |
| Water | 0.250 |

The mixture was blended using an auger speed of 120 rpm. Citric acid (0.018 kg) was added and the mixture was heated to 87° C. over a period of 1 min using direct steam injection. This temperature was maintained for about 6 minutes. During the heating, approximately 1.06 kg of condensate was added and incorporated into the mixture.

The molten mixture was poured through a colloid mill before being cast on a chilled table, whereupon the film of cheese was cut into slices. The chilled slices of processed cheese were of acceptable quality for IWS (individually wrapped slice) application.

TABLE 3
Processed cheese composition

| Components | % |
|---|---|
| Fat | 28.6 |
| Moisture | 45.7 |
| Salt | 2.0 |
| Protein | 18.9 |
| Water | 0.250 |

### REFERENCES

1. Berger, W., Klostermeyer, H., Merkenich, K., Uhlmann, G., Processed Cheese Manufacture-A Joha® Guide. p 77, BK Giulini Chemie GmbH & Co. OHG, Ladenburg., 1993
2. Cheese: Chemistry, Physics and Microbiology, 2nd edn, Volume 2, Chapter 15, p 467. ed. P. F. Fox., Chapman & Hall, London, UK, 1993.
3. Creamer, L/K/ (1991) Bull Int Dairy Fed 2612, 14-28

1. A method of retarding or inhibiting the breakdown of intact casein in a cheese comprising subjecting the cheese to a pressure treatment of greater than 400 MPa.

2. A method according the claim 1 wherein the cheese is subjected to a pressure treatment of at least 500 MPa.

3. A method according to claim 2 wherein the cheese is subjected to a pressure treatment of at least 600 MPa.

4. A method according to claim 3 wherein the cheese is subjected to a pressure treatment of at least 700 MPa.

5. A method according to claim 4 wherein the cheese is subjected to a pressure treatment of at least 800 MPa.

6. A method according to claim 1 wherein the cheese is held at the treatment pressure for about 5 minutes.

7. A method according to claim 1 wherein the cheese is held at the treatment pressure for less than 5 minutes.

8. A method according to claim 1 wherein the cheese is held at the treatment pressure for about 3 minutes.

9. A method according to claim 7 wherein the cheese is held at the treatment pressure for about 1 minute.

10. A method according to claim 7 wherein the cheese is held at the treatment pressure for less than 1 minute.

11. A method according to claim 1 wherein the cheese is subjected to a pressure treatment within 30 days of being drained.

12. A method according to claim 11 wherein the cheese is subjected to a pressure treatment within 5 days of being drained.

13. A method according to claim 12 wherein the cheese is subjected to a pressure treatment less than 24 hours after being drained.

14. A method according to claim 1 wherein the cheese contains a coagulating enzyme derived from either a microbial or animal source.

15. A method according to claim 14 wherein the enzyme is a fermentation produced chymosin.

16. A method according to claim 14 wherein the cheese contains at least one enzyme selected from the following:
enzymes derived from Rhizomucor miehei;
enzymes derived from Rhizomucor pusillus;
enzymes derived from Endothia parasitica;
enzymes derived from Cryphonectria parasitica; and
Chymosin.

17. A method according to claim 1 wherein the cheese is pasta filata style cheese.

18. A method according to claim 1 wherein the cheese is a pizza cheese.

19. A method according to claim 1 wherein the cheese is Mozzarella.

20. A method of retarding or inhibiting the breakdown of intact casein in mozzarella cheese comprising subjecting the cheese to a pressure treatment of greater than 400 MPa.

21. A method according to claim 20 wherein the pressure treatment is 600 MPa.

22. A method according to claim 21 wherein the cheese is held at a pressure of about 600 MPa for about 5 minutes.

23. A method of making a cheese product comprising heating one or more cheeses with one or more emulsifying agents, wherein at least one cheese has been treated by subjecting the cheese to a pressure treatment of greater than 400 MPa.

24. A method according to claim 23 wherein the heating pasteurizes the cheese product.

25. A method according to claim 23 wherein the heating is between about 65 and 100 degrees Celsius for at least 30 seconds.

26. A method according to claim 25 wherein the heating is at about 65 degrees Celsius for about 30 seconds.

27. A method according to claim 23 wherein the cheese product is processed cheese.

28. A method according to claim 23 wherein the cheese product is processed cheese food.

29. A method according to claim 23 wherein the cheese product is processed cheese spread.

30. A method according to claim 1 where the pressure treated cheese is of a type selected from: cheddar, granular, stirred curd, Colby and “American” cheese variety.

31. Cheese produced by a method according to any one of claim 1.

32. Cheese produced by a method according to claim 23.
